(19) United States
(12) Patent Application Publication
(10) Pub. No.: US 2006/0155767 A1
(43) Pub. Date: Jul. 13, 2006

(54) Information recording-and-reproducing method and information recording-and-reproducing apparatus with play-list copy function

(75) Inventor: Akihiro Oishi, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/305,245

(22) Filed: Dec. 19, 2005

(30) Foreign Application Priority Data
Dec. 28, 2004 (JP) 2004-380179

(51) Int. Cl. G06F 17/30

(52) U.S. Cl. 707/104.1

(57) ABSTRACT

The present invention provides for an information recording-and-reproducing method and apparatus. At least one play-list file which stores information used for coupling at least two files to each other and for reproducing the files is generated, wherein the at least two files are coupled to each other at the heads and/or midpoints thereof. A first shortcut file is generated for at least one file included in the play-list file, and a second shortcut file is generated for the play-list file. The first shortcut file and the second shortcut file are generated in one and the same folder.

### BACKGROUND OF THE INVENTION

1. Field of the Invention

The present invention relates to an information recording-and-reproducing method and an information recording-and-reproducing apparatus that can record and/or reproduce digital image data and digital audio data.

2. Description of the Related Art

To generate a desired image by using a randomly accessible information recording medium, a play list is typically used instead of changing original digital image data and original digital audio data. The play list shows information about the order in which a plurality of digital image data files and a plurality of digital audio-data files are reproduced. The play list further shows information about at least one part to be reproduced in each of the data files.

Further, when a generated play list is copied to a different recording-and-reproducing apparatus or to a personal computer (PC), a generated play-list file, and digital-image data and digital audio data written in the generated play-list file are copied to the recording-and-reproducing apparatus or the PC.

However, the digital image data and the digital audio data may not typically be stored in one and the same folder. Namely, the digital image data and the digital audio data are typically stored in different folders according to the file number and/or the data type. Therefore, for copying the play list, the play-list file is read and files written therein are located one by one. Japanese Patent Laid-Open No. 2004-172887 discloses a technology relating to the above-described configuration.

For copying the play list to a different recording-and-reproducing apparatus or the like, the play-list file is typically opened, the files written therein are checked one by one, so as to determine the positions where the files are recorded, and the files are specified and copied one by one. Therefore, if the play list includes a large number of files, a large number of processing procedures have to be performed, since the positions of files written in the play list are located one by one. Therefore, it typically takes much time for copying the play list.

### SUMMARY OF THE INVENTION

The present invention provides an information recording-and-reproducing method and an information recording-and-reproducing apparatus that can more easily copy a play list.

The information recording-and-reproducing method includes the steps of generating at least one play-list file which stores information used for coupling at least two files to each other and for reproducing the at least two files, wherein the at least two files are coupled to each other at the heads and/or midpoints thereof, and generating a first shortcut file for at least one file included in the play-list file, and a second shortcut file for the play-list file. The first shortcut file and the second shortcut file are generated in one and the same folder.

The information recording-and-reproducing apparatus includes a first unit configured to generate at least one play-list file which stores information used for coupling at least two files to each other and for reproducing the files, wherein the at least two files are coupled to each other at the heads and/or midpoints thereof, and a second unit configured to generate a first shortcut file for at least one file included in the play-list file, and a second shortcut file for the play-list file. The first shortcut file and the second shortcut file are generated in one and the same folder.

Further features of the present invention will become apparent from the following description of exemplary embodiments with reference to the attached drawings.

### BRIEF DESCRIPTION OF THE DRAWINGS

FIG. 1 is a block diagram illustrating an information recording-and-reproducing apparatus according to an embodiment of the present invention.

FIGS. 2A and 2B show the configuration of compressed data according to an embodiment of the present invention.

FIG. 3A shows the configuration of a play list according to an embodiment of the present invention.

FIG. 3B shows an example of information written in a play-list file.

FIG. 4 is a flowchart showing processing procedures performed for generating the play list according to an embodiment of the present invention.

FIG. 5A shows the configuration of data in the state where the play list is not yet generated according to an embodiment of the present invention.

FIG. 5B shows the configuration of data in the state where the play list is generated according to an embodiment of the present invention.

FIG. 6 shows an example of information written in a shortcut file.

FIG. 7 shows data areas of an information recording medium according to an embodiment of the present invention.

FIG. 8 is a flowchart illustrating processing procedures performed for copying the play list according to an embodiment of the present invention.

### DESCRIPTION OF THE EMBODIMENT

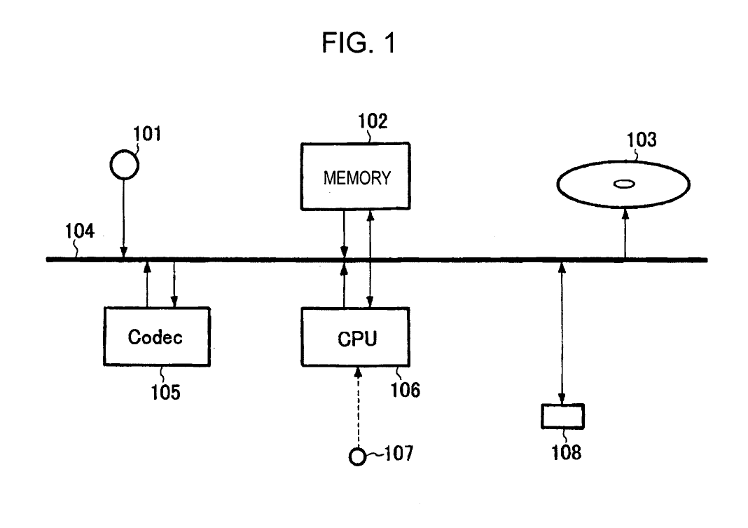

Representative embodiments of the present invention will now be described in detail with reference to the attached drawings. FIG. 1 is a block diagram illustrating an information recording-and-reproducing apparatus according to an embodiment of the present invention. As shown in FIG. 1, an input terminal 101, a memory 102, and a randomly-accessible information-recording medium 103 including an optical disk or the like are provided in the information recording-and-reproducing apparatus. Further, a bus 104, an image-and-audio encoder-and-decoder (codec) 105, a CPU 106, a command-input terminal 107, and a digital-interface terminal 108 are provided in the information recording-and-reproducing apparatus.

Digital-image data and digital-audio data transmitted from the input terminal 101 are stored in the memory 102 via the bus 104. The digital-image data and the digital-audio data stored in the memory 102 are encoded into compressed data by the image-and-audio codec 105 according to instruction information transmitted from the CPU 106 and stored in the memory 102. The compressed data stored in the memory 102 is stored in the information-recording medium 103 via the bus 104 according to instruction information transmitted from the CPU 106. An optical head or the like configured to store and/or reproduce data in/from the information-recording medium 103 will not be described.

The information-recording medium 103 stores not only the compressed data, but can also store a management-information file which is generated by the CPU 106 and which is used for managing the internal configuration of the information-recording medium 103. The management-information file includes information about at least one folder stored in the information-recording medium 103, so as to show which folder includes the compressed file. Further, the management-information file stores information about the record-start address and/or the data amount of each of the entire compressed files stored in the information-recording medium 103.

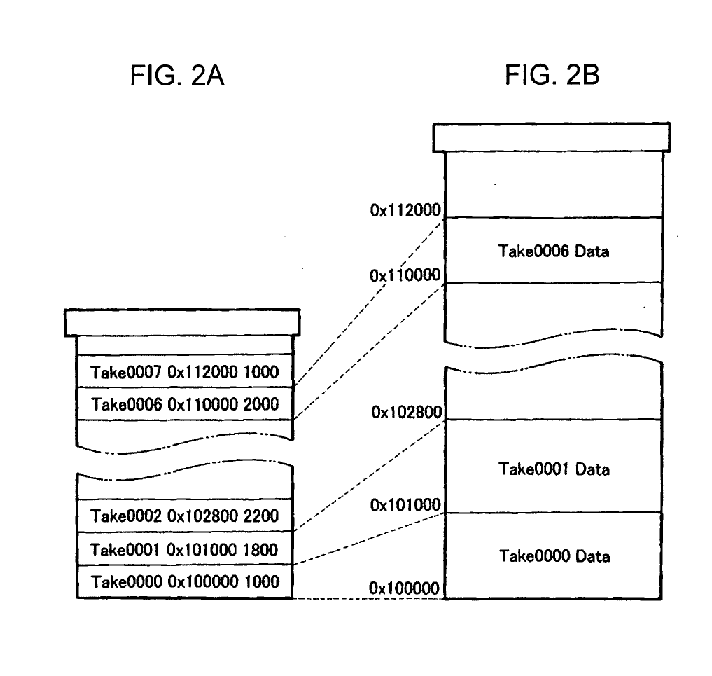

FIGS. 2A and 2B show the configuration of compressed data according to an embodiment of the present invention. The compressed data is stored in a predetermined folder selected according to the number and/or the type of files that can be stored in the folder. FIG. 2A shows management information with the file name, the record-start address, and the data amount. FIG. 2B shows a file itself, where the value written in part at the lower left shows the record-start address.

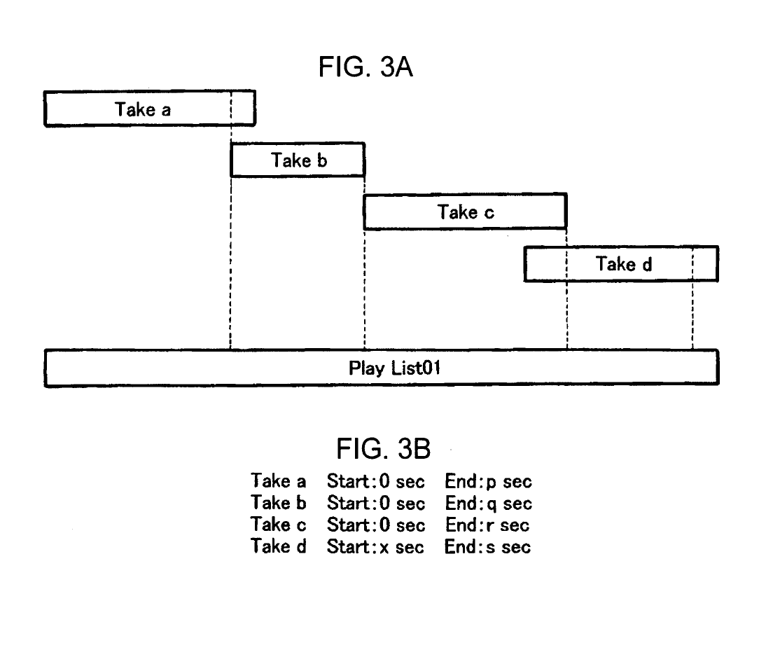

FIG. 3A shows the configuration of the play list according to an embodiment of the present invention, and FIG. 3B shows an example of information written in the play-list file. In this regard, a play-list file typically stores information used for coupling a plurality of image files and a plurality of audio files to one another.

Returning to FIG. 1, the processing procedures performed for generating the play-list file in accordance with an embodiment of the present invention will be described. First, for generating the play-list file, play-list information is transmitted from the command-input terminal 107 to the CPU 106, where the play-list information shows the start position and reproduction time of each of specified moving-image files and audio files. The CPU 106 generates a play-list file and stores the play-list file in the information-recording medium 103. Then, the CPU 106 generates another folder and further generates a shortcut of the play-list file and that of each of the moving-image files and audio files stored in the play-list file. The shortcut of the play-list file, and those of the moving-image files and audio files, are stored in the folder.

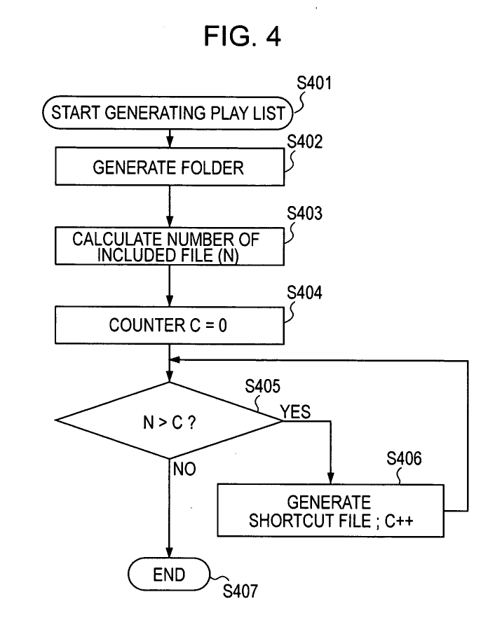

FIG. 4 is a flowchart showing processing procedures performed by the CPU 106 for generating the play list according to an embodiment of the present invention. When the processing procedures are started, the CPU 106 generates the play-list file in the above-described manner, at step S401. Then, the CPU 106 generates another folder, at step S402. Then, at step S403, the CPU 106 calculates the number of files (N) stored in the play-list file, and generates and stores the shortcut of the play-list file in the folder generated at step S402.

The value of a counter C is set to zero, that is, an initial value, at step S404. The counter C is configured to count the number of generated shortcut files.

Next, the number of files stored in the play-list file (N) is compared to the value of the counter C, at step S405. Since the value of the counter C is zero at first, the flow proceeds to step S406 where the shortcut file is generated for the file stored in the play-list file and the counter C is incremented. The flow then returns to step S405. When the value of the file number N is larger than that of the counter C, the shortcut file of at least one file stored in the play-list file is also generated and the counter C is also incremented, at step S406.

When the value of the file number N becomes equal to that of the counter C, at step S405, it means that the shortcut file had been made for each of the entire files. Subsequently, the processing procedures end, at step S407. Thus, the shortcut files are made.

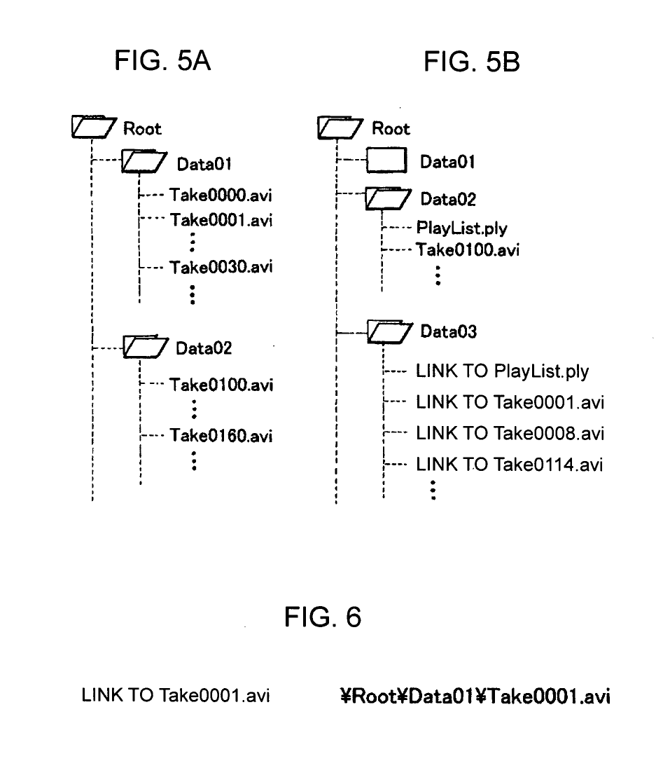

FIGS. 5A and 5B show the configuration of data according to an embodiment of the present invention. FIG. 5A shows the configuration of data in the state where the play list is not yet generated. After the play-list file is generated, the play-list file is stored, as a link file, as shown in FIG. 5B. FIG. 6 shows an example of information written in the shortcut file. Namely, the information shows the position where a specified file exists.

Next, returning to FIG. 1, operations performed for copying the play-list file to another recording-and-reproducing apparatus or to a PC, for example, will be described. First, the information recording-and-reproducing apparatus is connected to a different recording-and-reproducing apparatus via the digital-interface terminal 108 so that data can be copied. Upon receiving information for specifying data to be copied via the command-input terminal 107, the CPU 106 specifies a predetermined address in the information-recording medium 103, reads data, and transmits the data from the digital-interface terminal 108 to the different recording-and-reproducing apparatus via the bus 104.

When copying an ordinary file, an address and a data amount on the information-recording medium 103 are read from the management-information file shown in FIG. 2A and a specified file shown in FIG. 2B is read.

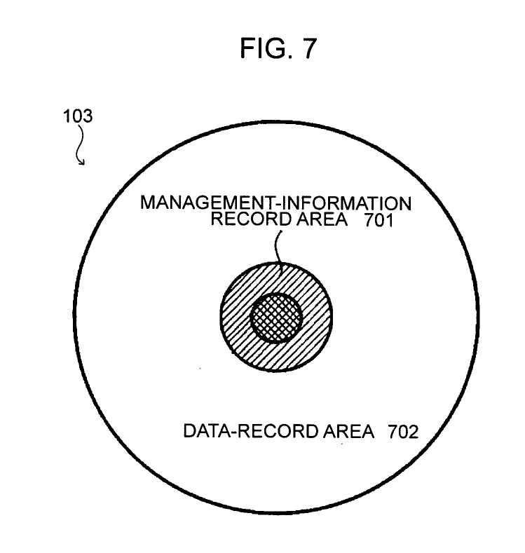

FIG. 7 shows data areas provided on the information-recording medium 103 according to an embodiment of the present invention. A management-information record area 701 storing management information is provided on an inner-area of the information-recording medium 103. Further, a data-record area 702 storing image data and/or audio data, for example, is provided on an outer-area of the information-recording medium 103.

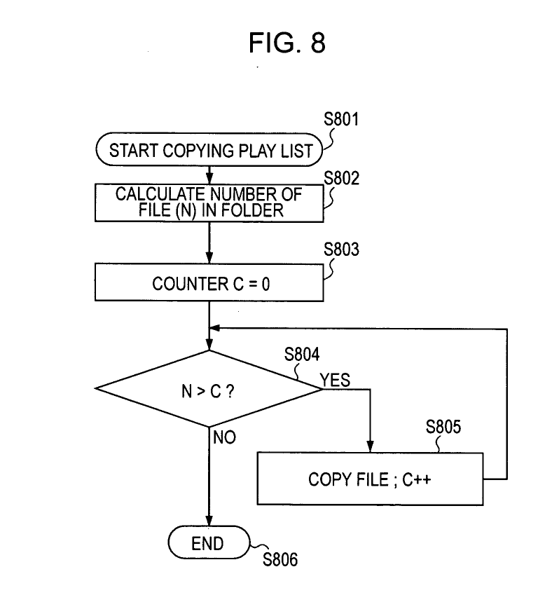

Next, processing procedures performed for copying the play-list file in accordance with an embodiment of the present invention will be described. FIG. 8 is a flowchart illustrating processing procedures performed by the CPU 106, so as to copy the play-list file. First, when the processing procedures are started for copying the play-list file, at step S801, a folder storing the shortcut of a specified play list and the shortcut file of at least one file included in the play list is opened, and the number of files (N) stored in the folder is calculated, at step S802.

Next, the value of the counter C is set to zero, that is, an initial value, at step S803. The counter C counts how many times the file stored in the folder is copied. Then, the file number N is compared to the value of the counter C, at step S804. Since the value of the counter C is zero at first, the flow proceeds to step S805 where the shortcut file stored in the folder is copied and the counter C is incremented. The flow then returns to step S804. When the value of the file number N is larger than that of the counter C, the shortcut file is copied and the counter C is incremented, as is the above-described case, at step S805.

When the value of the file number N becomes equal to that of the counter C, at step S804, it means that the shortcut file of each of the entire files stored in the folder is copied. Subsequently, the processing procedures end, at step S806. Thus, the shortcut files are copied.

When an instruction to copy a shortcut file is issued in the above-described information recording-and reproducing apparatus, the CPU 106 searches for a main-body file based on address information written in the shortcut file and operates, so as to copy the main-body file. At that time, the shortcut file itself is not copied. The above-described function can also be provided for an operating system (OS) of UNIX. Therefore, the above-described function can be easily achieved by providing the function to an OS running on the CPU 106.

While the present invention has been described with reference to representative embodiments, it is to be understood that the invention is not limited to the disclosed representative embodiments. The scope of the following claims is to be accorded the broadest interpretation so as to encompass all modifications, equivalent structures and functions.

This application claims the benefit of Japanese Application No. 2004-380179, filed Dec. 28, 2004, which is hereby incorporated by reference herein in its entirety.

What is claimed is:

1. An information recording-and-reproducing method comprising the steps of:
generating at least one play-list file which stores information used for coupling at least two files to each other and for reproducing the at least two files, wherein the at least two files are coupled to each other at the heads and/or midpoints thereof; and
generating a first shortcut file for at least one file included in the play-list file, and a second shortcut file for the play-list file,
wherein the first shortcut file and the second shortcut file are generated in one and the same folder.

2. The information recording-and-reproducing method according to claim 1, wherein the at least two files include at least one of a moving-image-data file and an audio-data file.

3. An information recording-and-reproducing apparatus comprising:
a first unit configured to generate at least one play-list file which stores information used for coupling at least two files to each other and for reproducing the at least two files, wherein the at least two files are coupled to each other at the heads and/or midpoints thereof; and
a second unit configured to generate a first shortcut file for at least one file included in the play-list file, and a second shortcut file for the play-list file,
wherein the first shortcut file and the second shortcut file are generated in one and the same folder.

4. The information recording-and-reproducing apparatus according to claim 4, wherein in a case where an instruction is issued to copy the play-list file to a recording medium, the folder including the first and second shortcut files is opened, and a main body file of at least one of the first and second shortcut files is copied according to the link information written in the first and second shortcut files.
